(19) United States
(12) Patent Application Publication
(10) Pub. No.: US 2022/0001727 A1
(43) Pub. Date: Jan. 6, 2022

(54) CAR WING TYPE RAINWATER SHIELD DEVICE

(71) Applicant: Jun Gu KIM, Seoul (KR)

(72) Inventor: Jun Gu KIM, Seoul (KR)

(21) Appl. No.: 16/920,122

(22) Filed: Jul. 2, 2020

(51) Int. Cl. B60J 5/04

(52) U.S. Cl. CPC B60J 5/0494

(57) ABSTRACT

The present invention relates to a car wing type rainwater shield device that is configured to have bat wing-like shields unfolded to the outsides of a car when it rains, while the shields are being controlled in such a manner as to be moved up and down according to the amount of rain. The car wing type rainwater shield device includes: shield bodies located on both top sides of a car; a rainwater sensor located on one side of the car to sense changes in an outside environment of the car; and a controller adapted to produce a driving signal for the shield bodies according to a signal inputted by a user's terminal or a signal value measured by the rainwater sensor and to control upward and downward movements of the shield bodies and a degree of unfolding of the shield bodies according to the signal value measured by the rainwater sensor in a state where the shield bodies are driven.

### TECHNICAL FIELD

The present invention relates to a car wing type rainwater shield device, and more particularly, to a car wing type rainwater shield device that is configured to have bat wing-like shields unfolded to the outsides of a car when it rains, while the shields are being controlled in such a manner as to be moved up and down according to the amount of rain.

### BACKGROUND

If it rains, while a car is being driven, a driver or passenger as well as an interior of the car may be wet with the rain at the time when he or she opens a door of the car to get in or out of the car.

So as to solve the above-mentioned problems, a car wing type rainwater shield is disclosed in Korean Patent Application Laid-open No. 10-2017-0081591 as filed by the same applicant as the invention.

The conventional car wing type rainwater shield is fixed to one side of top of a car by means of a fixing bar, and if it rains, a fixing loop accommodated in the side surface of the shield is pulled and fixed to top of a car door. Accordingly, the shield can be unfolded widely to a shape of a wing according to an opening angle of the car door.

As the conventional car wing type rainwater shield is configured to pull and fix the fixing loop to top of the car door, however, it fails to completely prevent a driver and a passenger from being wet with the rain.

### SUMMARY

Accordingly, the present invention has been made in view of the above-mentioned problems occurring in the prior art, and it is an object of the present invention to provide a car wing type rainwater shield device that is configured to have bat wing-like shields unfolded to the outsides of a car when it rains, while the shields are being controlled in such a manner as to be moved up and down according to the amount of rain.

To accomplish the above-mentioned object, according to the present invention, there is provided a car wing type rainwater shield device including: shield bodies located on both top sides of a car; a rainwater sensor located on one side of the car to sense changes in an outside environment of the car; and a controller adapted to produce a driving signal for the shield bodies according to a signal inputted by a user's terminal or a signal value measured by the rainwater sensor and to control upward and downward movements of the shield bodies and a degree of unfolding of the shield bodies according to the signal value measured by the rainwater sensor in a state where the shield bodies are driven.

According to the present invention, desirably, each shield body includes: a housing disposed on one side of top of the car and having a space formed at the inside thereof; a fixing bar fixed to the inside of the housing in such a manner as to be rotated according to a control signal; a frame fixed to one side of the fixing bar in such a manner as to be folded normally and unfolded to the outside when it rains; a shield whose one is fixed to the fixing bar and the other end is fixed to one side of the frame in such a manner as to be drawn according to the unfolding of the frame; and auxiliary frames spaced apart from each other by a given distance at the inside of the shield.

According to the present invention, desirably, the frame includes: a pair of first frames fixed to one side of the fixing bar; a second frame fixedly connected to the pair of first frames in such a manner as to be maintained in a state of being laid on the first frames, normally and moved outward from the pair of first frames when it rains; and a third frame fixedly connected to the other end of the second frame in such a manner as to allow one end of the shield to be fixed thereto.

According to the present invention, desirably, the controller divides the signal value measured by the rainwater sensor into a plurality of signal values, so that if the divided signal value is greater than a threshold value, the controller moves the shield bodies down and if the divided signal value is less than the threshold value, the controller moves the shield bodies up.

According to the present invention, desirably, the fixing bar is rotated by a given set angle to move the shield body up or down, and a rotating angle of the fixing bar when the shield body is moved up is bigger than a rotating angle of the fixing bar when the shield body is moved down.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a top view showing a car wing type rainwater shield device according to the present invention;

FIG. 2 is a top view showing a state where shield bodies of FIG. 1 are mounted on a car;

FIG. 3 is a perspective view showing the shield body of FIG. 1;

FIG. 4 is a flowchart showing a method for driving the car wing type rainwater shield device of FIG. 1;

FIG. 5 is a perspective view showing a state where the car wing type rainwater shield device according to the present invention is unfoldedly drawn to the outside;

FIG. 6 is a front view showing a state where a fixing bar is rotated to move a shield up; and

FIG. 7 is a front view showing a state where the fixing bar is rotated to move the shield down.

### DETAILED DESCRIPTION OF THE PREFERRED EMBODIMENTS

Now, an explanation on a car wing type rainwater shield device according to the present invention will be given with reference to the attached drawings. In the description, the thicknesses of the lines or the sizes of the components shown in the drawing may be magnified for the clarity and convenience of the description.

Further, the terms as will be discussed later are defined in accordance with the functions of the present invention, but may be varied under the intention or regulation of a user or operator. Therefore, they should be defined on the basis of the whole scope of the present invention.

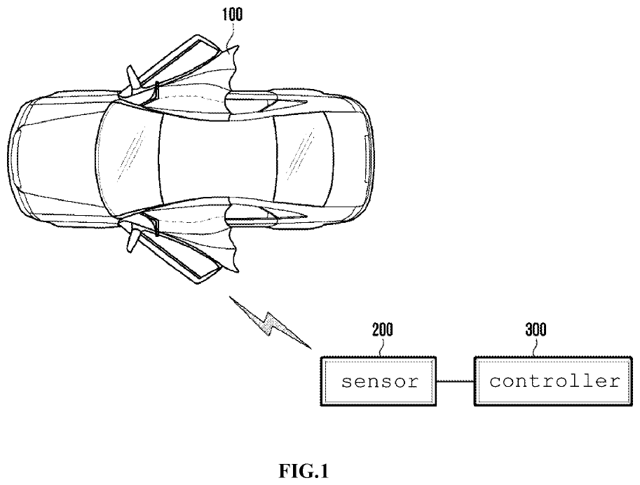

Hereinafter, a car wing type rainwater shield device according to the present invention will be in detail explained with reference to FIG. 1.

FIG. 1 is a top view showing a car wing type rainwater shield device according to the present invention.

As shown in FIG. 1, a car wing type rainwater shield device according to the present invention includes shield bodies 100, a sensor 200, and a controller 300.

First, the shield bodies 100 are located on both top sides of a car and have bat wing-like shapes inserted into housings as will be discussed later, normally and unfolded outward when it rains. Further, the shield bodies 100 can be moved up or down according to an amount of rain sensed in a state of being unfolded, thereby preventing a driver and a passenger from being wet with the rain when they get out of the car.

The sensor 200 is located on one side of the car to sense changes in an outside environment of the car. The car wing type rainwater shield device according to the present invention is configured to allow the shield bodies 100 to be unfolded when it rains, and accordingly, the sensor 200 is desirably adapted to sense rainwater.

Lastly, the controller 300 is adapted to control a degree of unfolding of the shield bodies 100 and upward and downward movements of the shield bodies 100 according to a signal value received from the sensor 200.

In detail, the controller 300 turns the shield bodies 100 on or off by means of a driving signal inputted by a user or the signal value received from the sensor 200. Further, the controller 300 sets a threshold value to allow the shield bodies 100 to be moved up and down according to the signal value received from the sensor 200.

Also, the controller 300 compares the set threshold value with the signal value received from the sensor 200, and if the signal value received from the sensor 200 is bigger than the set threshold value, the controller 300 transmits a control signal so that the shield bodies 100 are moved down. Contrarily, if the signal value received from the sensor 200 is smaller than the set threshold value, the controller 300 transmits a control signal so that the shield bodies 100 are moved up.

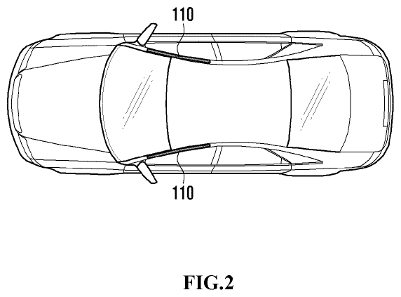

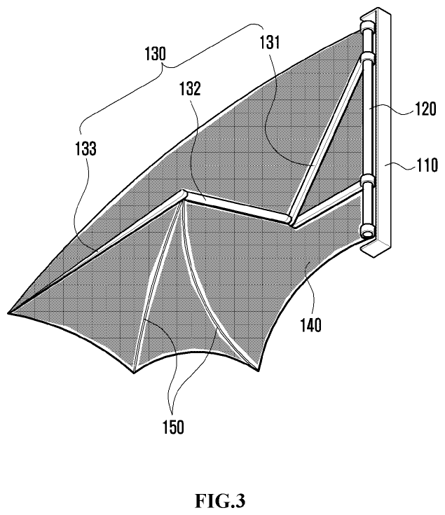

Hereinafter, the shield bodies 100 according to the present invention will be in detail explained with reference to FIGS. 2 and 3.

FIG. 2 is a top view showing a state where the shield bodies of FIG. 1 are mounted on the car, and FIG. 3 is a perspective view showing the shield body of FIG. 1.

As shown in FIGS. 2 and 3, each shield body 100 according to the present invention includes a housing 110, a fixing bar 120, a frame 130, a shield 140, and auxiliary frames 150.

First, the housing 110 is disposed on one side of a car roof in such a manner as to be open on one side thereof. The housing 110 is adapted to accommodate the fixing bar 120, the frame 130, the shield 140, and the auxiliary frames 150 therein and has a box-like shape. Normally, the housing 110 is configured to allow the fixing bar 120, the frame 130, the shield 140, and the auxiliary frames 150 to be foldedly laid on one another at the inside thereof, and if the control signal is received from the controller 300, the housing 110 is configured to allow the frame 130 to be drawn to the outside.

The fixing bar 120 is fixed to the inside of the housing 110 in such a manner as to be rotated if necessary. If the control signal is received from the controller 300, the fixing bar 120 is not rotated by 360°, but rotated by set angles. In detail, if the control signal for the upward movement of the shield body 100 is received from the controller 300, the fixing bar 120 is rotated by an angle of about 60°, and if the control signal for the downward movement of the shield body 100 is received from the controller 300, the fixing bar 120 is rotated by an angle of about 45°. According to the present invention, the rotating angles of the fixing bar 120 are set to 60° and 45°, but they are just examples. Accordingly, they may be arbitrarily set by a user.

As shown in FIG. 3, the frame 130 includes a pair of first frames 131, a second frame 132, and a third frame 133.

First, one pair of first frames 131 whose one end is connected to the fixing bar 120 and the other end is connected to each other has a shape of a triangle.

Next, the second frame 132 is fixedly connected to the first frames 131 so that normally, it is maintained in a state of being laid on the first frames 131, but when it rains, it is moved outward from the first frames 131.

Lastly, the third frame 133 whose the other end is fixed to the shield 140 as will discussed later is fixedly connected to the other end of the second frame 132.

The frame 130 is foldedly accommodated in the housing 110 in such a manner as to allow the third frame 133 to be first drawn and unfolded to the outside. On the other hand, a degree of unfolding of the frame 130 can be controlled. In detail, the frame 130 is step by step drawn to the outside in order of the third frame 133, the second frame 132, and the first frames 131. Accordingly, only the third frame 133, only the third frame 133 and the second frame 132, or all of the third frame 133, the second frame 132, and the first frames 131 may be drawn to the outside by means of the signal inputted by the user or the signal outputted from the sensor 200.

Next, the shield 140 has a bat wing-like shape and is fixed to the frame 130. The shield 140 is made of a fabric like canvas so that it can be folded or unfolded together with the frame 130.

As the shield 140 is made of the fabric, the auxiliary frames 150 are disposed on the inner side of the shield 140 so as to allow the shield 140 to be tensely fixed in every direction.

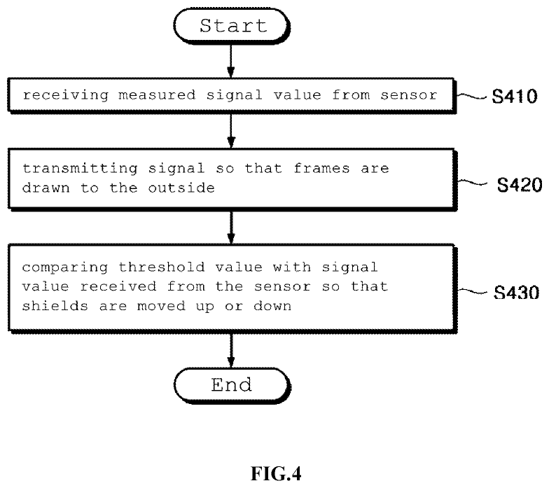

Hereinafter, an explanation on a method for driving the car wing type rainwater shield device according to the present invention will be in detail given with reference to FIGS. 4 to 7.

FIG. 4 is a flowchart showing a method for driving the car wing type rainwater shield device according to the present invention.

As shown in FIG. 4, first, the car starts or a separate driving switch is turned on by the user to drive the shield bodies 100.

If the shield bodies 100 are driven, the controller 300 receives the measured signal value from the sensor 200 at step S410.

The sensor 200 is located on one side of the car to sense whether it rains. Further, the sensor 200 measures the amount of rain to transmit the measured signal value to the controller 300.

Next, the controller 300 transmits a signal according to the signal value received so that the frames 130 of the shield bodies 100 are drawn to the outside at step S420.

In this case, the controller 300 controls the frames 130 so that each frame 130 is step by step unfolded to the outside in order of the third frame 133, the second frame 132, and the first frames 131, and of course, the degree of unfolding of the frames 130 can be controlled according to the signal inputted by the user.

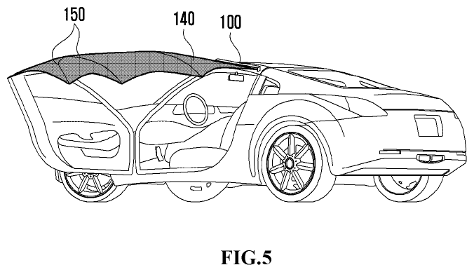

If the frame 130 is unfoldedly drawn outward from the housing 110, as shown in FIG. 5, the controller 300 compares the set threshold value with the signal value received from the sensor 200, so that it controls the shield bodies 100 according to the compared result to allow the shield bodies 100 to be moved up or down at step S430.

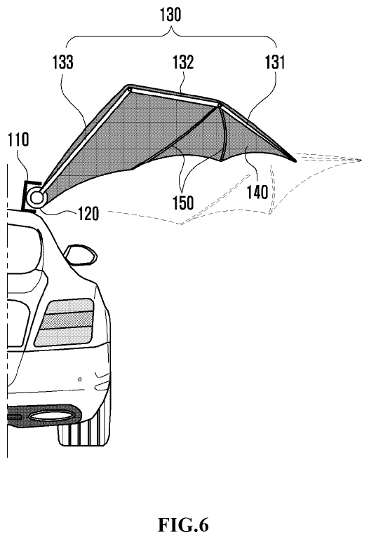

In detail, the threshold value is already set in the controller 300. Accordingly, if the signal value received from the sensor 200 is smaller than the set threshold value, the controller 300 transmits a control signal so as to allow the shield body 100 to be moved up. As a result, as shown in FIG. 6, the fixing bar 110 is rotated by a given set angle to allow the shield body 100 to be moved up.

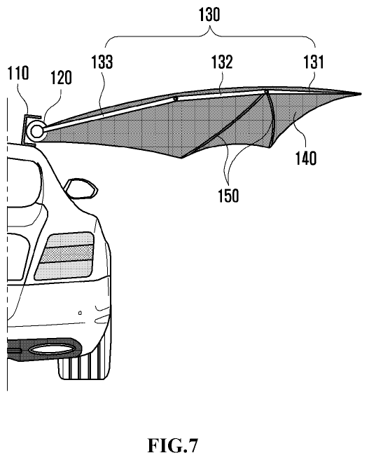

Contrarily, if the signal value received from the sensor 200 is bigger than the set threshold value, the controller 300 transmits a control signal so as to allow the shield body 100 to be moved down. As a result, as shown in FIG. 7, the fixing bar 110 is rotated by a given set angle to allow the shield body 100 to be moved down.

As described above, the car wing type rainwater shield device according to the present invention is configured to allow the shields folded to be automatically unfolded by means of the sensor located on the car to thus prevent the driver and the passenger from being wet with the rain when they get out of the car. In addition, the car wing type rainwater shield device according to the present invention can control the upward and downward movements of the shields and the unfolding degree thereof according to the amount of rain.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A car wing type rainwater shield device comprising:
shield bodies located on both top sides of a car;
a rainwater sensor located on one side of the car to sense changes in an outside environment of the car; and
a controller adapted to produce a driving signal for the shield bodies according to a signal inputted by a user's terminal or a signal value measured by the rainwater sensor and to control upward and downward movements of the shield bodies and a degree of unfolding of the shield bodies according to the signal value measured by the rainwater sensor in a state where the shield bodies are driven.

2. The car wing type rainwater shield device according to claim 1, wherein each shield body comprises:
a housing disposed on one side of top of the car and having a space formed at the inside thereof;
a fixing bar fixed to the inside of the housing in such a manner as to be rotated according to a control signal;
a frame fixed to one side of the fixing bar in such a manner as to be folded normally and unfolded to the outside when it rains;
a shield whose one is fixed to the fixing bar and the other end is fixed to one side of the frame in such a manner as to be drawn according to the unfolding of the frame; and
auxiliary frames spaced apart from each other by a given distance at the inside of the shield.

3. The car wing type rainwater shield device according to claim 2, wherein the frame comprises:
a pair of first frames fixed to one side of the fixing bar;
a second frame fixedly connected to the pair of first frames in such a manner as to be maintained in a state of being laid on the first frames, normally and moved outward from the pair of first frames when it rains; and
a third frame fixedly connected to the other end of the second frame in such a manner as to allow one end of the shield to be fixed thereto.

4. The car wing type rainwater shield device according to claim 1, wherein the controller divides the signal value measured by the rainwater sensor into a plurality of signal values, so that if the divided signal value is greater than a threshold value, the controller moves the shield bodies down and if the divided signal value is less than the threshold value, the controller moves the shield bodies up.

5. The car wing type rainwater shield device according to claim 4, wherein the fixing bar is rotated by a given set angle to move the shield body up or down, and a rotating angle of the fixing bar when the shield body is moved up is bigger than a rotating angle of the fixing bar when the shield body is moved down.
